(19) United States
(12) Patent Application Publication
(10) Pub. No.: US 2003/0141628 A1
(43) Pub. Date: Jul. 31, 2003

(54) Molding method for protective equipment

(75) Inventor: Ching-Hsi Chen, Taichung (TW)

Correspondence Address: TROXELL LAW OFFICE PLLC, SUITE 1404, 5205 LEESBURG PIKE, FALLS CHURCH, VA, 22041, US

(73) Assignee: SUN OWN INDUSTRIAL CO., LTD.

(21) Appl. No.: 10/058,760

(22) Filed: Jan. 30, 2002

(51) Int. Cl. B29C 43/20

(52) U.S. Cl. 264/321; 264/325

(57) ABSTRACT

A molding method for protective equipment includes seven steps. A first step is to prepare a mold consisting of an upper and a lower mold respectively provided with a mold hole. A second step is to heat the mold to a preset first temperature. A third step is to place a plastic plate and a foam member in the mold. A fourth step is to move the upper mold nearer to the lower mold, and then close up the upper mold on the lower mold in a preset time for the two materials to melt. A fifth step is to heat the mold to a second temperature higher than the first temperature so that the outer surface of the two materials may melt. A sixth step is to cool the mold to a preset temperature to let the two materials cool to form a shape. The seventh step is to open the mold and take out a finished product.

### BACKGROUND OF THE INVENTION

This invention relates to a molding method for protective equipment, particularly to one capable to sufficiently connecting a plastic plate and a foam member of a piece of protective equipment y and molding the both in shape at the same time without any adhesive periphery.

Ball games such as baseball, basketball, football, hockey, cricket, etc. are very popular sports, and players may be often hurt or wounded in playing exciting games, so they have to protect their bodies with a sort of protective equipment.

Protective equipment generally has a curved plastic plate and a layer of foam member fixed inside the curved plastic plate, and in early days the foam member was commonly sawed together with the plastic plate by means of a cloth, requiring much labor and much time.

Now a comparative common method is to use a kind of glue for adhering a plastic plate with a foam member, so viscosity of glue, repellence of the peripheries, climate endurance and service life of the material have to be taken into consideration.

This kind of protective equipment made by the above-mentioned method may commonly soften or melt by a high temperature or may peel off after a long period of exposure to sunlight, wind and rain, which constitute serious drawback in its quality. Besides, in adhering process a plastic plate has to be molded first, and an accommodation and space for drying glue has to be prepared, complicating its process.

### SUMMARY OF THE INVENTION

A main purpose of the invention is to offer a molding method for protective equipment, in which a plastic plate and a foam member are sufficiently and firmly adhered together without any glued peripheries. The adhered positions of the both are quite compatible to each other with strong bonding, with the peripheries not repelling each other to produce peeling.

Another purpose of the invention is to offer a molding method for protective equipment, in which a plastic plate and a foam member may be molded integral and adhered together at the same time, not necessary to inject and mold a plastic plate at first, shortening its molding process.

One more purpose of the invention is to offer a molding method for protective equipment, in which an outer layer of a foam member may be formed by means of sealed mold hole inside a mold so as to prevent the foam member form producing bad odor when it absorbs moisture.

### BRIEF DESCRIPTION OF DRAWINGS

This invention will be better understood by referring to the accompanying drawings, wherein:

FIG. 1 is a perspective view of a piece of protective equipment produced by a molding method in the present invention FIG. 2 is a cross-sectional view of a plastic plate and a foam member to be placed in a mold in the present invention;

FIG. 3 is a cross-sectional view of an upper mold and a lower mold slowly moved nearer to each other in the present invention;

FIG. 4 is a cross-sectional view of the upper and the lower mold closed up together in the present invention;

FIG. 5 is a cross-sectional view of the piece of protective equipment finished in molding in the present invention;

FIG. 6 is a perspective and a part cross-sectional view of the piece of protective equipment in the present invention; and,

FIG. 7 is a flow chart of the molding method for protective equipment in the present invention.

### DETAILED DESCRIPTION OF THE PREFERRED EMBODIMENT

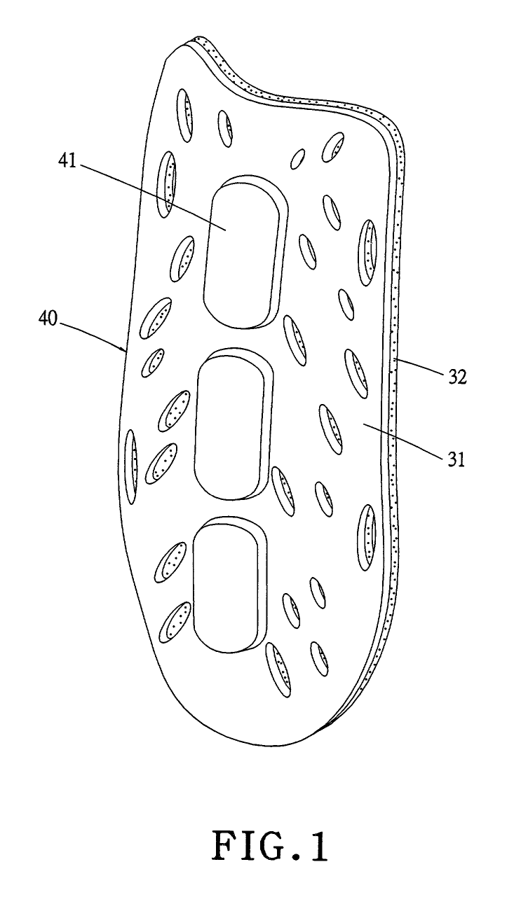

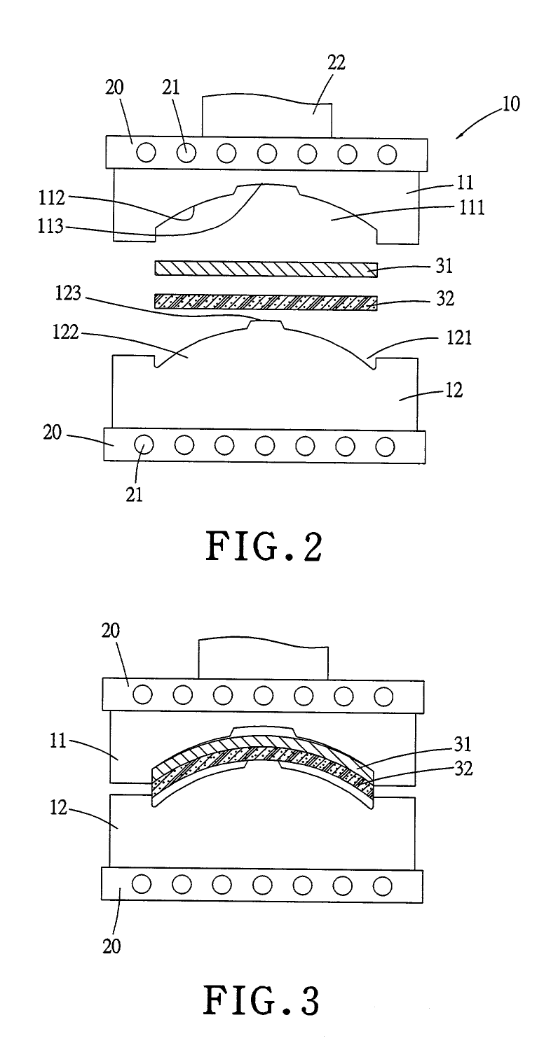

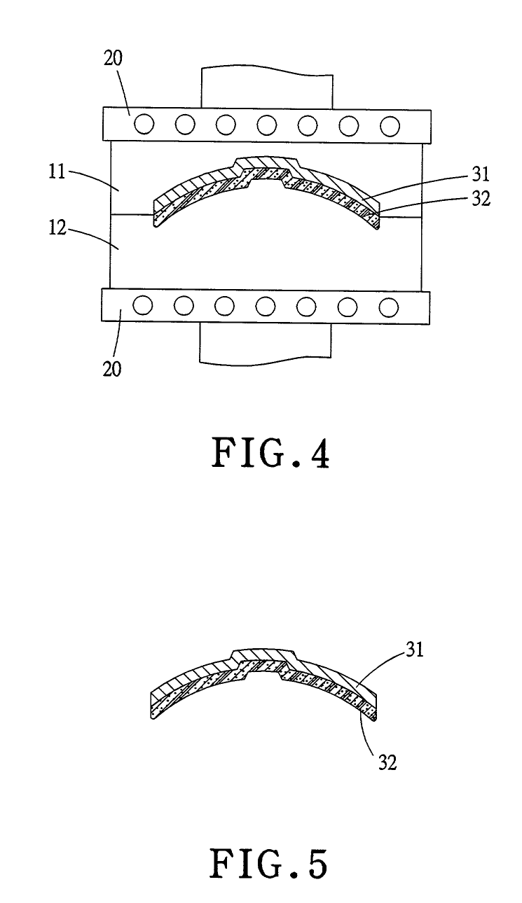

A preferred embodiment of a molding method for protective equipment in the present invention, as shown in FIGS. 1 and 2, includes seven steps of processes.

A first step is to prepare a mold 10 consisting of an upper mold 11 and a lower mold 12. The upper and the lower mold 11 and 12 respectively have an upper mold hole 111 of a preset shape and a lower mold hole 121 of a preset shape. The upper mold hole 111 has a recessed curved surface 112, and the lower mold hole 121 has a curved surface 122 symmetrical to the upper recessed curved surface 121. The upper mold hole 112 has at least a long groove 113 in the center, and the lower mold hole 122 has at least a long ridge 123 to correspond to the long groove 113. The width of the long ridge 123 is shorter than that of the long groove 113. Further, an oil-pressure cylinder 22 is positioned on the center of the upper mold 11, having its piston rod moving downward to push down the upper mold 11.

A second step is to heat the mold 10 to a preset first temperature. A heating device 20 is respectively provided on top of the upper mold 11 and under the bottom of the lower mold 12, having a plurality of heating tubes 21 arranged in its interior. Then hot steam is supplied in the heating tubes 21 to heat up both the upper and the lower mold 11 and 12 to the first temperature 80-135° C. at the same time.

A third step is to place a plastic plate 31 and a foam member 32 in the mold 10. As shown in FIGS. 1 and 2, a flat plastic plate and a flat foam member can be used in the invention, but of course, a curved plastic plate after injected and molded also can be used. The foam member 32 is to be placed on top of the lower curved surface 122 of the lower mold hole 121 first, and then the plastic plate 31 is placed on the foam member 32 in a piled-up condition. As to a plastic plate 31, non-foamed plate made of EVA, ps, or PE is usable, and for a foam member 32, a foam member made of EVA or PE having buffing or shock-absorbing characteristics can be used.

A fourth step is to move the upper mold 11 nearer to the lower mold to a preset location by means of the oil-pressure cylinder 22 and then close up the two molds 11 and 12 together in a preset time. Moving and closing up the two molds 11 and 12 is performed by the oil-pressure cylinder 22, requiting 30-120 seconds. At first the upper and the lower mold 11 and 12 are kept heated in a comparatively low temperature, letting the plastic plate 31 and the foam member 32 baked under a special location, a preset time, and a preset temperature to gradually soften for convenience of next process.

A fifth step is to heat up the mold 10 to a second temperature. The second temperature is higher than the first temperature, 120-150° C. Heating time is 3-10 minutes, and the higher the temperature, the shorter the heating time, and the thickness and the property of materials used have to be taken into consideration for selecting proper time. The purpose of heating is to melt a plastic plate 31 and a foam member 32 to fuse particles of the materials contacting with each other, and to inflate the air in the foam member so as to produce pressure to let molten foam member 32 flow along the space in the mold hole to fill the whole mold hole and form a complete structure. As the plastic plate and the foam member made of EVA or PA have very good compatibility, they can bond firmly together. In this embodiment, heating condition for melting a plastic plate 31 and a foam member 32 can effectively adhere the both 31 and 32.

A sixth step is to cool the mold 10 in the closed condition to a third temperature. The third temperature is much lower than the first and the second one, 20-40° C. Cooling is effected by leaking the hot steam out of the heating tubes 21, and then poring in cool water to let the material in the mold 10 cool and harden in shape.

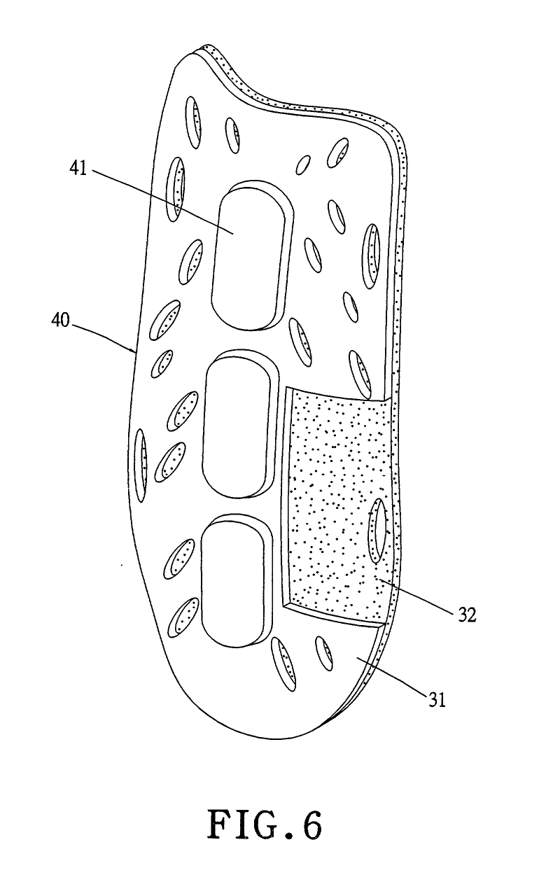

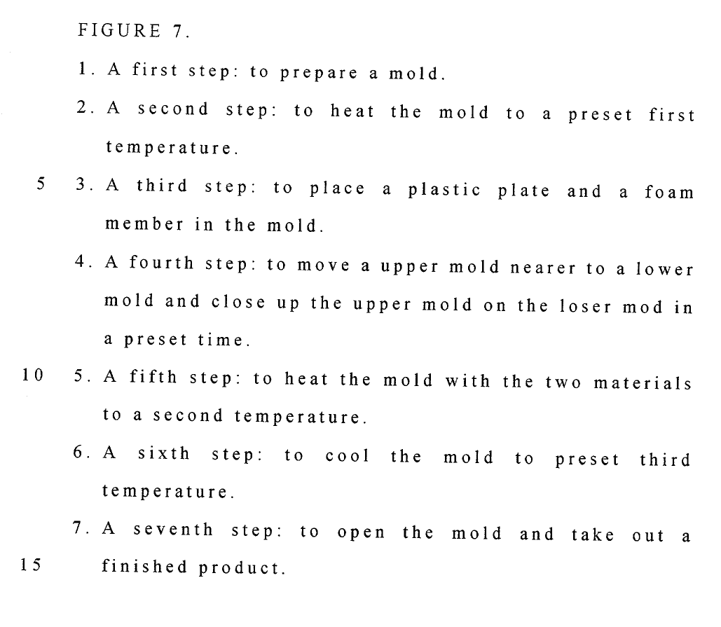

A seventh step is to open the mold 10 and take out a finished piece of protective equipment. A finished product of the plastic plate 31 and the foam member 32 is molded together as integral after the mold 10 is opened, as shown in FIGS. 1 and 6.

A technological means utilized in the invention is to melt a plastic plate 31 and a foam member 32 to a molten condition so that the particles of the contacting portions of the two materials 31 and 32 may fuse together naturally to become integral after molding. And bonding strength of the both materials 31 and 32 is very good, as the both materials are made of the same material, EVA, ps or PE, having good compatibility so as not to give rise to repellence between the peripheries or peeling phenomenon. So integrity, climate endurance and service life of products made according to the invention are better than the conventional ones.

Another technological advantage of the invention is to heat the upper and the lower mold 11 and 12 at the same time, and keep them in comparatively low temperature, and slowly moving the upper molds 11 nearer to the lower mold 12 so that a plastic plate 31 and a foam member 32 may be baked in a special location, s special time, and a special temperature to soften to be molded in shape, diminishing percentage of disqualified quality of products.

Further, the sealed mold hole in the mold 10 compels the air in a foam member 32 in a molten condition inflate to flow along the space of the mold hole and fill the whole mold hole to become not merely a complete structure but also an integral shape, designs or patterns on an outer surface of the plastic plate 31 and the foam member 32. For example, the upper mold hole 111 is provided with a preset number of long grooves 113 and the lower mold hole 121 is provided with a preset number of ridges 123 to permit a finished produce 40 of protective equipment formed with a plastic plate 31 provided with the same number of ridges 41, and a foam member provided with the same number of long grooves.

Besides, the sealed mold hole of the mold 10 permits a foam member in the mold 10 to shape a layer of skin of high density to prevent the foam member from producing bad odor when it absorbs moisture.

While the preferred embodiment of the invention has been described, it will be recognized and understood that various modifications may be made therein and the appended claims are intended to cover all such modifications that may fall within the spirit and scope of the invention.

I claim:

1. A molding method for protective equipment comprising:
A first step of preparing a mold consisting of an upper mold and a loser mold, said upper mold having an upper mold hole formed in a center portion, said lower mold having a lower mold hole to correspond to said upper mold hole;
A second step of heating said mold to a preset first temperature;
A third step of placing a plastic plate with a preset shape and a foam member with a preset shape in said mold;
A fourth step of moving slowly said upper mold nearer to said lower mold and then closing up the upper mold on said lower mold in a preset time, forcing said plastic plate and said foam member gradually melt;
A fifth step of heating said mold closed up to a second temperature, said second temperature being higher than said first temperature to let an outer surface of said plastic plate and said foam member to a molten condition;
A sixth step of cooling said mold to a preset third temperature, said third temperature being lower than said first and said second one so that said plastic plate and said foam member may be cooled and harden in shape; and,
A seventh step of opening said mold and taking out a finished product.

2. The molding method for protective equipment as claimed in claim 1, wherein said upper mold hole has a recessed curved surface, and said lower mold hole has a bossed curved surface symmetrical to said recessed curved surface.

3. The molding method for protective equipment as claimed in claim 1, wherein a heating device is provided respectively on top of said upper mold and under said lower mold, said first temperature for heating said mold is 80-135 C, and said second temperature for heating said mold is 120-150° C.

4. The molding method for protective equipment as claimed in claim 1, wherein said plastic plate is non-foamed plate made of EVA, ps or PE, and said foam member is a foam plate made of EVA, ps or PE having buffering and shock-absorbing characteristics.

5. The molding method for protective equipment as claimed in claim 1, wherein said upper curved surface of said upper mold has at least a groove at a preset location, and said lower curved surface of said lower mold has a ridge symmetrical to said groove, with a width of said ridge being shorter than that of said groove.
